(19) United States
(12) Patent Application Publication
(10) Pub. No.: US 2007/0182965 A1
(43) Pub. Date: Aug. 9, 2007

(54) Linked extendable gas observation system for infrared absorption spectroscopy

(75) Inventors: Leonard I. Kamlet, Andover, MA (US); Martin L. Spartz, Ellington, CT (US); Peter Rosenthal, W. Simsbury, CT (US)

Correspondence Address: PROSKAUER ROSE LLP, ONE INTERNATIONAL PLACE 14TH FL, BOSTON, MA, 02110, US

(73) Assignee: MKS Instruments, Inc., Wilmington, MA (US)

(21) Appl. No.: 11/529,694

(22) Filed: Sep. 28, 2006

Related U.S. Application Data
(60) Provisional application No. 60/721,515, filed on Sep. 28, 2005.

(51) Int. Cl. G01N 21/61; G01N 21/00

(52) U.S. Cl. 356/437

(57) ABSTRACT

A modular system for gas analysis has a first gas cell that receives and passes at least a portion of an infrared light beam through at least a portion of the first gas cell. A second gas cell disposed proximal to the first gas cell receives and passes at least a portion of the infrared light beam from the first gas cell through at least a portion of the second gas cell. At least a portion of the first gas cell and at least a portion of the second gas cell define a light path having an effective length. The system includes a means for adjusting the effective length of the light path to vary a property of the infrared light beam. Methods of making a variable effective length light path and methods of making a gas detector are also disclosed.

### RELATED APPLICATION

This application claims the benefit of and priority to U.S. Provisional Patent Application entitled “Linked Extendable Gas Observation System for Infrared Absorption Spectroscopy” filed on Sep. 28, 2005, U.S. Ser. No. 60/721,515, the entirety of which is incorporated by reference herein.

### FIELD OF THE INVENTION

The invention generally relates to the field of gas analysis. Specifically, the invention relates to a modular system for gas analysis in high purity analysis and gas delivery applications.

### BACKGROUND OF THE INVENTION

Industries, such as the semiconductor industry, requiring high purity gas employ gas delivery systems that contain a series of gas distribution and control components such as valves, flow controllers and pressure sensors. This series of components is often referred to as a gas stick. Gas delivery systems can be made up of a number of gas sticks, and are capable of delivering a single gas to multiple locations, a single gas to a single location, or multiple gases to a single location. Gas sticks enable gases to travel through ultrapure components with a minimum number of welded connections, which allows for system flexibility. These systems are designed such that components such as valves, flow controllers, and various sensors can be designed and redesigned in the systems with a straightforward path toward integration. The gas distribution and control components can be mounted using in-line or surface mount configurations, for example. As the needs of the high purity gas delivery applications increase, so do the requirements to precisely measure the concentrations of both the gases delivered and also the contaminants present in those gases.

### SUMMARY OF THE INVENTION

The invention provides a system for optical analysis of one or more gases in, for example, a gas delivery system. Currently available gas analysis systems are limited, because they only measure a single gas at a time. For example, known infrared gas analysis systems generally include a source for generating infrared light, optics for directing the infrared light into a single vessel or tube called a gas cell and a detector that detects the attenuation of the light beam as it passes through the gas. Electronics process and interpret the signal generated by the detector and provide information about the gas present in the single gas cell.

Known infrared gas analysis systems include single pass systems and multi-pass systems. Single pass systems include an infrared light source and a detector placed on opposite sides of a single gas cell having windows capable of allowing infrared light to pass through the single gas cell. The gas contained in the single gas cell is analyzed by measuring the attenuation of a sensing beam during a single traversal across the gas sample within the gas cell. Multi-pass systems similarly include a single gas cell between an infrared light source and a detector, but also employ reflecting surfaces that allow the infrared light beam to make multiple traversals through the sample gas before exiting the single gas cell for measurement. Thus, the reflecting surfaces allow for longer optical absorption path lengths within the gas sample while requiring very small gas cell dimensions. Longer path lengths enable a more sensitive measurement.

In one aspect, the invention relates to a modular system for gas analysis. The modular system includes a light source providing a light beam, a first modular gas cell, and a second modular gas cell. The first modular gas cell has an input side having a first panel and an output side having a second panel and at least a portion of the second panel is coincident with the first panel. The first modular gas cell receives at least a portion of the light beam and at least a portion of the light beam passes through the first panel and the coincident portion of the second panel. The second modular gas cell is disposed proximal to the first modular gas cell. The second modular gas cell has an input side having a third panel and an output side having a fourth panel. At least a portion of the fourth panel is coincident with the third panel and the second modular gas cell receives at least a portion of the light beam from the first modular gas cell. At least a portion of the light beam passes through the third panel and the coincident portion of the fourth panel. A light path having an effective length is defined by at least a portion of the first modular gas cell and at least a portion of the second modular gas cell. The modular system includes a means for adjusting the effective length of the light path to vary a property of the light beam. The modular system also includes a detector that detects the light beam received from the second modular gas cell.

In another aspect, the invention relates to a modular system for gas analysis. The modular system has a first gas cell that receives at least a portion of a light beam from a light source. At least a portion of the light beam passes through at least a portion of the first gas cell. A second gas cell is disposed proximal to the first gas cell. The second gas cell receives at least a portion of the light beam from the first gas cell. At least a portion of the light beam passes through at least a portion of the second gas cell. At least a portion of the first gas cell and at least a portion of the second gas cell define a light path having an effective length. The system includes a means for adjusting the effective length of the light path to vary a property of the infrared light beam. In one embodiment, the means for adjusting the effective length of the light path is at least a portion of one or more additional gas cell disposed proximal to the first gas cell. In another embodiment, the means for adjusting the effective length of the light path is one or more optical device disposed proximal to the first gas cell or one or more optical device disposed proximal to the second gas cell, the one or more optical device for directing the light beam. The one or more optical device can be, for example, a mirror, lens, or any combination of these. In another embodiment, the means for adjusting the effective length of the light path is an additional gas cell disposed proximal to the first gas cell and an optical device for directing the light beam. The means for adjusting the effective length of the light path can be changing the flow of a first gas flowing through a first gas cell relative to a second gas flowing through a second gas cell. In addition, the means for adjusting the effective length of the light path can include changing the gas cells through which one or more gas flows. In another embodiment, the means for adjusting the effective length of the light path includes at least one valve for controlling the flow of a gas to at least one gas cell. The system can also include a means to identify a substance (e.g., a gas and/or an impurity) in one or more gas cells. Suitable ways to identify a substance include, for example, altering a first gas flowing through the first gas cell relative to a second gas flowing through the second gas cell. Means to identify a substance include flowing a first gas through the first gas cell and a second gas through the second gas cell, for example, the first gas flows at a first pressure and the second gas flows at a second pressure, the first gas is a first temperature and the second gas is a second temperature, the first gas flows at a first pressure and is a first temperature and the second gas flows at a second pressure and is a second temperature, the first gas is absorbed by infrared light and the second gas is not absorbed by infrared light, the first gas is the same as the second gas, and/or the first gas and the second gas are absorbed by infrared light. In another embodiment, the system also includes a means to quantify the one or more substances in the system and/or the one or more substances exiting the system.

In another aspect, the invention relates to a system for gas analysis including a first gas cell defining a first volume and a second gas cell defining a second volume. The first gas cell receives at least a portion of a light beam from a light source and at least a portion of the light beam passes through at least a portion of the first volume. The second gas cell, including a second volume, is disposed proximal to the first gas cell and receives at least a portion of the light beam from the first volume. At least a portion of the light beam passes through at least a portion of the second volume. A detector receives at least a portion of the light beam from the second volume and detects a property of the light beam.

In one embodiment, a first gas flows through the first volume and a second gas flows through the second volume, optionally, the first gas is a different gas than the second gas. In one embodiment, the first gas is not absorbed by infrared light and the second gas is absorbed by infrared light. The system can further include a gas analyzer for analyzing the property of the light beam associated with one or more gas cells to determine, for example, the concentration of the first gas and the second gas or the total contaminant level of the first gas and the second gas. The system can also include a processor that converts the detected light beam into data.

The first cell can include an input side having a first panel and an output side having a second panel. In one embodiment, at least a portion of the second panel is coincident with the first panel and a light beam travels through the first panel and the coincident portion of the second panel. Each gas cell can define a light path length. The means for adjusting the effective length of the light path includes a means for adjusting the light path length of one or more gas cell. The property of the light beam can be the light beam intensity at one or more wavelength. In one embodiment, the light beam property is infrared light beam absorbance.

The system can include a light source for supplying the light beam. The light source can supply an infrared light beam, an ultraviolet light beam, a visual light beam or any combination of these. Also, the system can include a detector for detecting the property of the light beam associated with one or more gas cells. The detector detects, for example, the light beam received from the second gas cell.

In one embodiment, one or more gas cells are at least substantially the same size and shape. The one or more gas cells are, for example, modular. The first gas cell can be disposed on a first base and the second gas cell can be disposed on a second base, alternatively, both the first gas cell and the second gas cell can be disposed on a single base. A mechanical system can couple the input side of the second gas cell and the output side of the first gas cell. In addition, the mechanical system can seal an interface between an input side of the second gas cell and an output side of the first gas cell. In one embodiment, an o-ring, a polymer, an elastomer or a combination thereof is disposed between an input side of the second gas cell and an output side of the first gas cell.

In another embodiment, a beam splitter splits the light beam into at least a first light beam and a second light beam. A third gas cell, defining a third volume, receives at least a portion of the second light beam from the beam splitter and at least a portion of the second light beam passes through at least a portion of the third volume. A fourth gas cell is disposed proximal to the third gas cell. The fourth gas cell defines a fourth volume and receives at least a portion of the second light beam from the third volume. At least a portion of the second light beam passes through at least a portion of the fourth volume. The detector receives at least a portion of the second light beam from the fourth volume. The detector detects a property of the light beam associated with one or more gas cells.

In another aspect, the invention relates to a method of making a light path having a variable effective length. The method includes selecting a plurality of modular gas cells each defining a light path. The modular gas cells are connected to provide a combined light path having an effective length. The method can also include providing a light source for supplying a light beam to the plurality of gas cells. The beam can be an infrared light beam, an ultraviolet light beam, a visual light beam, or any combination of these. A detector for detecting a property of the light beam associated with one or more gas cells can also be provided. A base can be provided and one or more of the plurality of gas cells can be connected to the base and/or one of the plurality of gas cells can be connected to another of the plurality of gas cells. The method also includes flowing a first gas through one of the plurality of gas cells and flowing a second gas through another of the plurality of gas cells. In one embodiment, the first gas is not absorbed by an infrared light and the second gas is absorbed by an infrared light, in this way the effective path length is changed according to the type of gas (e.g., absorbed or non-absorbed) that flow through the plurality of gas cells.

In another aspect, the invention relates to a method of making a detector. The method includes providing a plurality of gas cells defining a light path, positioning, relative to a gas cell, a light source for supplying a light beam to the light path, and connecting relative to the light path a detector for detecting the light beam received from the light path. The method can also include disposing proximal to the first gas cell or the second gas cell one or more optical device for directing the light beam.

In another aspect, the invention relates to system for gas analysis. The system includes a first gas cell that receives at least a portion of a light beam from a light source. At least a portion of the light beam passes through at least a portion of the first gas cell. A second gas cell receives at least a portion of the light beam from the first gas cell. At least a portion of the light beam passes through at least a portion of the second gas cell. An optical device directs at least a portion of the light beam received from the light source, the first gas cell, or the second gas cell. The gas analysis system includes a means for moving the optical device relative to the light beam. Moving the optical device relative to the light beam can enable additional gas cells to become part of the effective path length of the light beam.

The gas analysis system provides a number of advantages. The system is modular enabling simple adjustment of the effective length of the light path to facilitate analysis sensitivity suited to one or more gas samples. Accordingly, gasses of different sensitivity can be measured by the modular system without the expense, difficulty, and time required adjust sensitivity by changing components in existing gas analysis systems. In addition, the modular gas analysis system enables the supply of a single gas to additional gas cells, to fewer gas cells, or replacement of one gas with another gas thereby dynamically changing the effective path length. The modular gas analysis system can be employed with existing gas delivery systems including, for example, gas sticks. The system combines the modularity of gas sticks with gas detection and analysis.

The foregoing and other objects, aspects, features, and advantages of the invention will become more apparent from the following description and from the claims.

### BRIEF DESCRIPTION OF THE DRAWINGS

The foregoing and other objects, feature and advantages of the invention, as well as the invention itself, will be more fully understood from the following illustrative description, when read together with the accompanying drawings which are not necessarily to scale.

FIG. 1 is a diagram of a gas analysis system including a light source, a first gas cell, a second gas cell, a detector and a processor.

FIG. 2A is a diagram of a gas analysis system including a light source, a first gas cell, a second gas cell, an additional gas cell, a detector and a processor.

FIG. 2B is a diagram of a gas analysis system including a light source, a first gas cell, a second gas cell, an additional gas cell, a base, a detector and a processor.

FIG. 2C is a diagram of a gas analysis system including a light source, a first gas cell, a second gas cell, an additional gas cell, optical devices, a detector and a processor.

FIG. 3 is a diagram of a modular gas analysis system including a light source, a first gas cell, a second gas cell, a detector and a processor.

FIG. 4 is a diagram of a gas analysis system including a light source, a first gas cell, a second gas cell, additional gas cells, a detector and a processor.

FIG. 5 is a diagram of a gas analysis system including a light source, a first gas cell, a second gas cell, additional gas cells, optical devices, a detector and a processor.

FIG. 6 is a diagram of a gas analysis system including a light source, a beam splitter, a first gas cell, a second gas cell, additional gas cells, a detector and a processor.

FIG. 7 is a diagram of a gas analysis system including a light source, a light beam, a first gas cell, a second gas cell, additional gas cells, optical devices, and a detector.

FIG. 8 is a diagram of a gas analysis system including a light source, a light beam, a first gas cell, a second gas cell, additional gas cells, optical devices, a means for moving an optical device relative to the light beam, and a detector.

FIG. 9 illustrates a gas analysis system including two or more gas sticks disposed between a light source and a detector, a gas cell is disposed on each gas stick.

FIG. 10 illustrates a gas analysis system including two or more gas sticks and two optical devices disposed between a light source and a detector, a gas cell is disposed on each gas stick.

### DETAILED DESCRIPTION OF THE INVENTION

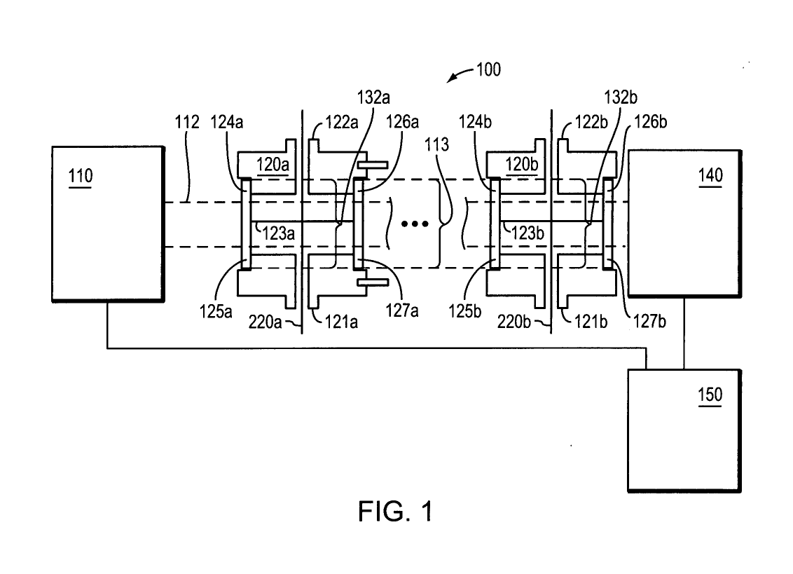

The invention provides a system and method for analysis of one or more gases contained in or flowing through a plurality of gas cells. Referring to FIG. 1, a system 100 for gas analysis includes a light source 110, two or more gas cells 120a, 120b, and a detector 140. In one embodiment, gas stream 220a flows through the first gas cell 120a and gas stream 220b flows through the second gas cell 120b. The gas stream 220a can be the same, a different concentration, or a different gas from gas stream 220b. Gas refers to both gases and vapors. The light source 110 emits light and can generate a single light beam 112. The light source 110 can be, for example, a source of infrared light, ultraviolet light, visible light, or a combination of these. In one embodiment, the light beam 112 can be an infrared light beam. The light source 110 emits a light beam 112 and the light beam 112 is optionally directed via a system of mirrors (not shown) into a series of gas cells 120a, 120b. The light source 110 is, for example, a Fourier Transform Infrared (FTIR) light source or an interferometer. The detector 140 can be any optical sensing device or material such as Mercury Cadmium Telluride for detecting infrared light. In other embodiments, an FTIR spectrometer that provides both an infrared light source 110 and an infrared light detector 140 can also be employed. Suitable FTIR spectrometers include an InDuct™ exhaust line gas analyzer available from MKS Instruments, Inc., Wilmington, Mass.

The system 100 provides a light source 110 for transmitting a single light beam 112 through two or more gas cells 120a, 120b, in series. Gas cells 120a, 120b are single pass transmission cells. The first gas cell 120a receives at least a portion of the light beam 112 from the light source 110. At least a portion of the light beam 112 passes through at least a portion of the first gas cell 120a. Gas cell 120a has an input side 124a having a first panel 125a and an output side 126a having a second panel 127a. At least a portion of the second panel 127a is coincident with the first panel 125a and at least a portion of the light 112 beam travels through the first panel 125a and the coincident portion of the second panel 127a. A second gas cell 120b is disposed proximate to the first gas cell 120a. The second gas cell 120b receives at least a portion of the light beam 112 from the first gas cell 120a and at least a portion of the light beam 112 passes through at least a portion of the second gas cell 120b. Specifically, at least a portion of the light beam 112 that exits the second panel 127a, enters the second gas cell 120b and similarly travels through the first panel 125b in the input side 124b of the second gas cell 120b to the coincident portion of the second panel 127b in the output side 126b of the second gas cell 120b.

The coincident portion of the input side and the output side of each gas cell provides an optical interface through which at least a portion of the light beam 112 can travel through each gas cell. Specifically, in gas cell 120a, the optical interface 132a includes an input side 124a having a first panel 125a, an output side 126a having a second panel 127a, and at least a portion of the light beam 112 travels through the optical interface 132a. In gas cell 120b, the optical interface 132b includes an input side 124b having a first panel 125b, an output side 126b having a second panel 127b, and at least a portion of the light beam 112 travels through the optical interface 132b. In one embodiment, the input side 124a, 124b and output side 126a, 126b of gas cells 120a, 120b, respectively, have dimensions that are compatible thereby enabling an optical interface 113 between gas cells 120a, 120b in a series through which the light beam 112 can pass. In this manner, at least a portion of the light beam 112 travels through all of the gas cells 120a, 120b in a series to reach the detector 140. In contrast to applications where a light beam is split into multiple beams each having less energy, because a single light beam 112 passes in a series through all of the gas cells 120a, 120b, more light beam 112 energy is available to probe every gas cell 120a, 120b. As a result, the signal to noise ratio is improved and the sensitivity and/or measurement speed is increased relative to systems where the light beam 112 is split.

At least a portion of the first gas cell 120a defines a light path 123a and at least a portion of the second gas cell 120b defines a light path 123b. The effective length of the light path can be measured between the inside portion of each panel, e.g., the effective length of the light path 123a is from inside the gas cell 120a volume from 125a to 127a. The effective length of the light path of gas cells 120a and 120b is, therefore, the sum of the effective length of light paths 123a, 123b. The panels 125a, 127a, 125b, and 127b can, like windows, be made from glass, polymers, or other materials capable of passing light. A single gas cell can feature one or more panels made from one or more materials.

In one embodiment, the first gas cell 120a defines a first volume and receives at least a portion of the light beam 112 from the light source 110. At least a portion of the light beam 112 passes through at least a portion of the first gas cell 120a. A second gas cell 120b defines a second volume and is disposed proximal to the first gas cell 120a. The second gas cell 120b receives at least a portion of the light beam 112 from the first gas cell 120a and at least a portion of the light beam 112 passes through at least a portion of the second gas cell 120b. The detector 140 (e.g., a gas detector) receives at least a portion of the light beam 112 from the second volume (i.e., the gas cell 120b). The detector 140 detects a property of the light beam 112. In one embodiment, the detector detects a property of the light beam 112 associated with one or more gas cells. For example, the detector detects a property of the light beam 112 associated with the first gas cell 120a and the second gas cell 120b.

The detector 140 can detect the light beam 112 received from the second gas cell 120b. The detector 140 detects the property of the light beam 112 associated with one or more gas cells 120a, 120b. In one embodiment, the detector 140 is a photometer that is utilized to measure a plurality of gas samples or gas streams 220a, 220b through which a light beam 112 (e.g., infrared light beam, ultra violet beam, visible light beam) from a single light source 110 passes. In one embodiment, a plurality of gas samples or gas streams 220a, 220b pass through two or more gas cells 120a, 120b, respectively. Each gas cell 120a, 120b, can be plumbed to carry gas streams 220a, 220b, without mixing. The gas streams 220a, 220b can originate from the same source or from different sources. Because the single light beam 112 travels through a series of gas cells 120a, 120b, the gas analysis system 100 is capable of monitoring dissimilar gases flowing through gas streams 220a, 220b, measuring the total level of a particular gas, and/or for measuring the total level of a contaminant and/or an impurity over all the gas cells 120a, 120b. The contaminant and/or impurity levels can range from, for example, a small amount to an abundance flowing through two or more gas cells 120a, 120b. The property of the light beam 112 can be the light beam intensity at one or more wavelength.

The light beam 112 traces its path sequentially through every cell 120a, 120b. The detector 140 detects the light beam 112 that has traveled through two or more gas cells 120a, 120b in a series. A spectrum (e.g., an infrared spectrum) is generated and a processor 150 containing signal processing electronics and a data reduction computer having suitable computer algorithms process the information detected by the detector 140. Suitable computer algorithms that process the detected light beam into information and/or data can be in the form of software. The processor 150 can convert the detected light beam into data regarding the gas cell(s) and substances flowing through the gas cells. For example, the data can indicate the type of gas, concentration of gas, type of impurity, concentration of impurity, type of contaminant, quantity of contaminant, and other available information regarding the gas that is known to the skilled person.

In an embodiment of a single gas analysis system 100, where one or more gas cells 120a, 120b contain different gases (e.g., the gas stream 220a is a different gas than the gas stream 220b), it is possible to determine the individual concentrations within each gas cell 120a, 120b. Specifically, one may take advantage of the fact that distinct gases flowing through gas streams 220a, 220b each have a unique absorption spectra (e.g., an infrared absorption spectra) and thereby determine individual gases and concentrations within each cell 120a, 120b. In this case, preferably the user is aware that each gas cell 120a, 120b, in the light path contains a distinct gas with a unique absorption spectrum.

In one embodiment, an array of gas lines 120a, 120b is monitored for a contaminant, such as moisture. When the detector 140 detects a variance from the expected total moisture level measured across all gases sampled from gas streams 220a, 220b it is possible to detect the source of gas that contains the contamination (e.g., the moisture). Specifically, each of the gas streams 220a, 220b, feeding each gas cell 120a, 120b is sequentially purged and the contaminated line is isolated by the process of elimination. For example, when a summed contaminant level of all of the gases being analyzed exceeds an expected amount, one or more valve feeding the gas stream 220a, 220b, lines can be closed and, by the process of elimination, the contaminated line is determined.

Most approaches to optical sensing of the gases in gas streams 220a, 220b, provide a measurement of the total number of absorbing molecules with the gas cell 120a, 120b. To convert this to concentration into a value, such as parts per million, it is necessary to know the total pressure and temperature of the gas streams 220a, 220b. Accordingly, the gas cells 120a, 120b, can be heated to a known temperature, or alternatively, a means for measuring the gas cell temperature such as a thermocouple or other temperature sensor (not shown) can be included in the system 100. Pressure sensing devices (not shown) can be employed to monitor the gas cell 120a, 120b pressure. Suitable pressure sensing devices for use in monitoring the gas cell pressure include, for example, capacitance manometers. While the use of temperature, pressure, and flow sensors is optional, use of such sensors within the system enables improved accuracy in gas concentration measurements.

It is possible to use the gas analysis system 100 to monitor pollution levels in multiple lines carrying exhaust gas (e.g., gas streams 220a, 220b flowing exhaust gas) from one or more pollution abatement system. In another embodiment, the gas analysis system 100 is employed to monitor the total level of a contaminant summed across a set of gas streams 220a, 220b. In still another embodiment, the gas analysis system 100 monitors the concentration of individual gases flowing through gas streams 220a, 220b during the creation of calibrated gas mixture. Optionally, the individual gas stream 220a, 220b concentrations are monitored in real time during the creation of calibrated gas mixtures. It is also possible to integrate the gas analysis 100 system into typical industrial and laboratory gas delivery systems including gas delivery systems for ultra-high purity gases, such as systems used to provide process gases for semiconductor manufacturing that employ, for example, gas sticks.

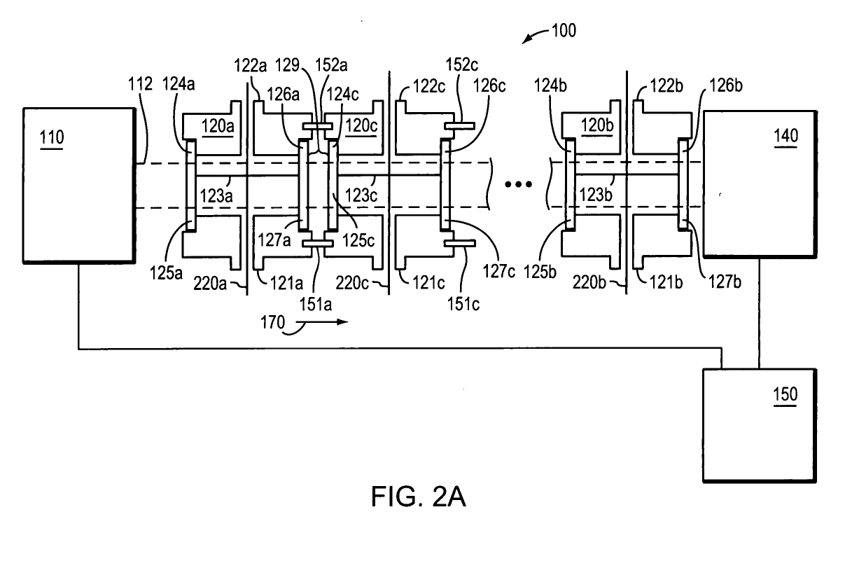

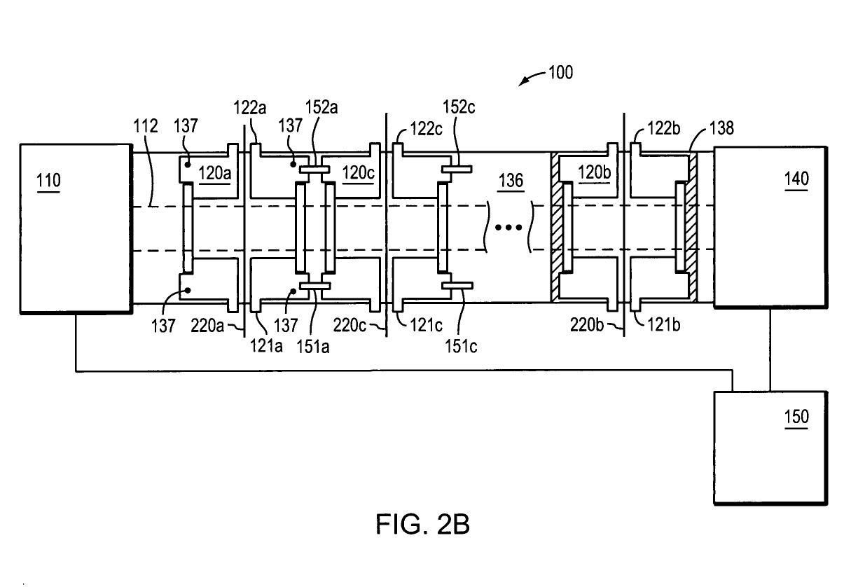

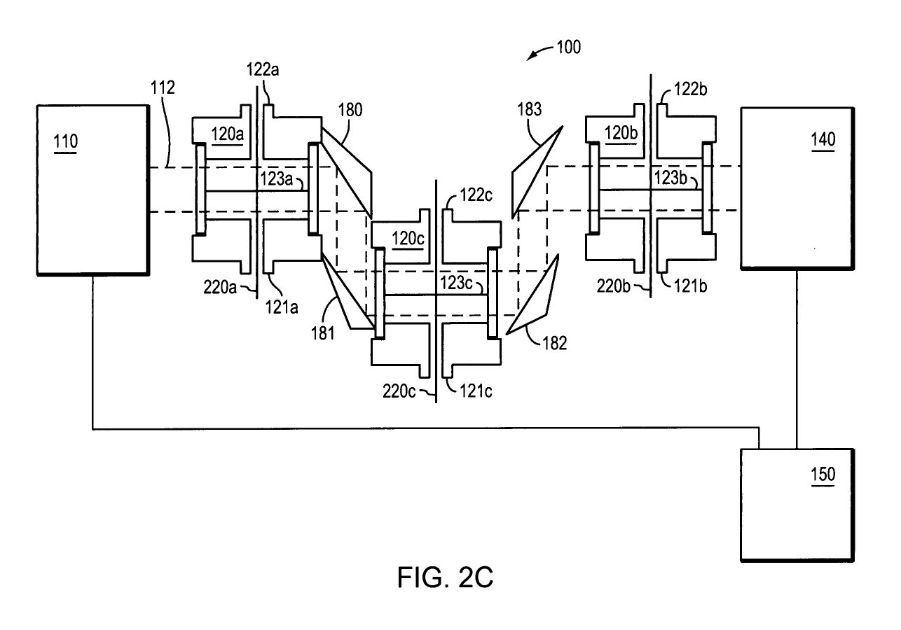

Referring now to FIG. 2A, the gas analysis system 100 has a modular structure, making it easily extendable for measuring multiple gas streams 220a, 220c, 220b. The modular system offers the flexibility to easily modify the effective length of the light path. This contrasts with existing gas analysis systems, where the gas cell is typically a fixed component regardless of the specific gases flowing through the gas analysis system. In existing gas analysis systems, it is difficult, time consuming, and/or expensive to modify the effective path length, because existing gas analysis systems are relatively inflexible. Many currently-available, inflexible gas systems require redesign to change sensitivity. The system 100 includes a means for adjusting the effective length of the light path (e.g., the sum of the effective lengths of light paths 123a, 123c, 123b) to vary a property of the light beam 112. In one embodiment, the means for adjusting the effective length of the light path is at least a portion of one or more additional gas cells (i.e., 120c) disposed proximal to the first gas cell 120a. In one embodiment, the one or more gas cell 120c defines a volume. The effective length of the light path is the sum of the effective length of light paths 123a, 123c, 123b. Any number of additional gas cells suitable for the gas or gases that are analyzed can be added to the system 100 and be placed, for example, proximal to the first gas cell 120a. Each of the gas cells (e.g., 120a, 120b, 120c) can have at least substantially the same size and shape.

Each gas cell 120a, 120b, 120c also features a means for delivering the gas stream 220a, 220b, 220c into and out of the gas cell 120a, 120b, 120c. Each gas cell 120a, 120c, 120b has a gas inlet 121a, 121c, 121b and a gas outlet 122a, 122c, 122b, respectively. A separate gas stream 220a, 220c, 220b can flow through each gas cell 120a, 120c, 120b in the direction of, for example, the gas inlet 121a, 121c, 121b toward the gas outlet 122a, 122c, 122b, respectively. One or more gas streams 220a, 220c, 220b can flow in the opposite direction. Because the light beam 112 is transmitted through the two or more gas cells 120a, 120c, 120b, it is possible to simultaneously measure multiple gas streams (e.g., 220a, 220c, 220b) using a single light source 110 and detector 140.

In surface mount designs, the gas inlet 121a and the gas outlet 122a are both in the bottom of the gas cell 120a. This allows the panels 125a, 127a on the input side 124a and the output side 126a, respectively, to be situated on the cell 120a without interference from the gas inlet 121a and gas exit 122a points. In an embodiment of an in-line gas configuration, the gas inlet and outlet points are located parallel to but below the panels 125a, 127a on the input side 124a and the output side 126a of the gas cell 120a, respectively. In an in-line configuration, internal conduits within the body of the gas cell couple the gas flow into the gas cell.

In one embodiment, the light source 110 is an FTIR. Infrared light is typically generated from a heated infrared source, which is then substantially collimated, and is then passed through an interferometer, which modulates each wavelength of infrared light with a unique amplitude modulation frequency. The light beam 112 is modulated infrared light that is delivered into the gas cell 120a. As the infrared light traverses the gas cell 120a, the gaseous molecular species within the gas cell 120a selectively absorb the infrared light at characteristic wavelengths. Other types of light can similarly be selectively absorbed. By measuring the intensity of light transmitted through the gas cell 120a as a function of wavelength, it is thus possible to determine the species and concentrations of the various gases within the gas cell 120a. Similarly, by measuring the intensity of light transmitted through gas cells in series 120a, 120c, 120b as a function of wavelength, it is possible to determine the species and concentrations of the various gases streams 220a, 220c, 220b within the gas cells 120a, 120c, 120b, respectively. The same principles can be applied to any of a number of gas cells in a series through which a light beam 112 can be transmitted. A different gas can pass through each gas cell 120a, 120c, 120b, for example, gas streams 220a, 220c, 220b each are a different gas type. Alternatively, the same gas can be passed through one or more of the multiple cells 120a, 120c, 120b to give an effective path length that is longer than the effective path length of any single gas cell within the design. For example, when gas streams 220a, 220c, 220b flow a single gas through multiple gas cells 120a, 120c, 120b in the modular gas analysis system 100, the effective path length is the sum of the effective length of light paths 123a, 123c, 123b.

One or more of the gas streams (e.g., 220a and 220c) can be a non-absorbing gas, such as, N₂ and other of the gas streams (e.g., 220b) can be an absorbing gas. In one embodiment, the effective path length can be altered by, for example, changing the number of gas cells the absorbing gas flows through relative to the number of gas cells the non-absorbing gas flows through (e.g., redirecting the flow of a non-absorbing gas to gas cell 120c to flow an absorbing gas through both gas cells 120c and 120b). Altering the flow of absorbing gas relative to non-absorbing gas impacts the optical ratio and the effective path length. The system for gas analysis can be automated or, optionally, can feature little to no automation.

The means for adjusting the effective length of the light path can include changing the flow of one gas stream relative to another gas stream. The flow change can be the type of gas, the presence of gas, and/or the absence of gas flowing through one or more of the gas cells. For example, the gas stream 220a flows gas “L”, the gas stream 220c flows gas “N”, and the gas stream 220b flows gas “M” until the flow is altered so that gas streams 220a and 220c both flow gas “L” and gas stream 220b flows gas “M”.

The means for adjusting the effective length of the light path can include at least one valve for controlling the flow of gas to a gas cell. The valve can be adjusted to prevent the flow of gas, enable the flow of gas, or change the rate of flow of a gas, for example. In this way, valves impact the presence and quantity of gas in the system.

The gas analysis system can also include means to identify a substance in one or more gas cells. The substance can be, for example, the gas, a contaminant, or an impurity. The means to identify a substance in one or more gas cells can include altering one gas flowing through a gas cell relative to another gas flowing through another gas cell. For example, a first gas stream flowing through a first gas cell is altered relative to a second gas stream flowing through a second gas cell. Specifically, where the gas stream 220a flows gas “L”, the gas stream 220c flows gas “N”, and the gas stream 220b flows gas “M” altering the flow so that gas streams 220a and 220c both flow gas “L” and gas stream 220b flows gas “M” enables substance detection. For example, an impurity in gas “N” is detected when a previously detected impurity is no longer detected in the altered flow arrangement in which gas “N” does not flow through the system. Similarly, an impurity in gas stream “L” can be confirmed when, upon altering the flows to increase the flow of gas “M”, the detected impurity remains at an initial level and/or and does not increase as would be expected if gas “M” contained the impurity.

A substance can be identified in one or more gas cells by, for example, altering the pressure of one cell relative to another cell. The effective length of the light path traversing the gas cell will be altered by the change in pressure. For example, where a gas containing a level of water impurity flows through a first gas cell 120a increasing the pressure of the first gas cell 120a while maintaining the pressure of another gas cell 120c will increase the molecules of water flowing through the first gas cell 120a and this change impacts the effective length of the light path traversing the first gas cell 120a.

In another embodiment, a substance is identified by flowing a first gas through a first gas cell at a first temperature and flowing a second gas through a second gas cell at a second temperature. In one embodiment, the presence and/or concentration of impurity is detected in each of the gases 220a and 220c flowing through the gas cells 120a and 120c, respectively. For example, where the impurity in each gas is water, the presence and/or concentration of water can be identified by the spectra that is expected at the given temperature of each gas cell (e.g., the spectra of water impurity in the gas cell 120a when the gas cell 120a is held at 35° C. varies from the spectra of water impurity in the gas cell 120c when the gas cell 120c is held at 100° C.). Gas cell pressure can similarly be employed to identify a substance in one or more gas cell, because the presence and/or concentration of a substance can be identified by the spectra that is expected at the given pressure of each cell. Optionally, in the gas analysis system, each gas cell has a distinct temperature and/or pressure. Distinct pressure and/or temperatures in each gas cell can help to determine and/or monitor each cell that is analyzed at, for example, a given time.

In one embodiment, a substance is identified by flowing a gas “P” that is absorbed by infrared light through a first gas cell and flowing a gas “Q” that is not absorbed by infrared light through a second cell. Where a gas analysis system features multiple gas cells, gas “P”, which is absorbed by infrared light, flows through a first gas cell and one or more non-absorbing gas flows through the remaining gas cells enabling, for example, determination of a substance in gas “P”.

In another embodiment, in a gas analysis system featuring two or more gas cells, initially an absorbing gas “P” flows through a gas cell 120a and a non-absorbing gas “Q” flows through a gas cell 120b. When the flow is changed so that the same gas flows through both the first gas cell and the second gas cell, e.g., absorbing gas “P” flows through both gas cells 120a and 120b, the increased flow of absorbing gas “P” enables determination of a substance in gas “P”. Substances in the non-absorbing gas such as, for example, impurities can be detected by flowing non-absorbing gas “Q” through both gas cells 120a and 120b.

The systems ability to identify substances such as, for example, gases, impurities and/or gas concentrations can enable real-time monitoring capabilities. For example, where various streams of gases employed in the semiconductor industry enter the gas analysis system after entering the manufacturing facility and exit the gas analysis system prior to entering the manufacturing process, the gas analysis systems ability to identify substances enables impurities, incorrect gases, and/or incorrect gas concentrations to be identified prior to enter the manufacturing process. In addition, the information and data generated by the gas analysis system can corroborate that correct gases, concentrations, and purity levels were introduced to a manufacturing process. This data is useful for determining causation of failures downstream in a manufacturing process, for example, the data can be employed to rule out a faulty gas stream as a cause of a product failure.

In another embodiment, the gas analysis system also includes a means to quantify one or more substances in the system and/or one or more substances exiting the system. By monitoring the gas flow into the gas analysis system and the gas flow exiting the gas analysis system, the substances in the system can be quantified. As described above, the substances and/or the concentration of the substances in the gas analysis system are identified, the flow rate of the gas(s) entering the system are monitored, and the concentration and flow rate are employed to determine the quantity of material entering, flowing through, and/or exiting the gas analysis system. Specifically, in order to quantify the substance in the first gas cell, the gas flow rate of the first gas, measured in liters/minute, is multiplied by the concentration of a substance in the first gas such as the concentration of the impurity water, measured in grams/liter, to provide the grams/minute of the impurity, i.e., water, flowing through the first gas cell. The rate at which the first gas exits the gas analysis system can be controlled by, for example, an exit valve or a mass flow controller that controls the rate at which the first gas exits the gas analysis system and enters, for example, a semiconductor process. The flows of each gas entering, flowing through, and existing the gas analysis system can similarly be monitored.

The gas analysis system 100 can include one or more alignment features 151a, 152a, 151c, 152c. Alignment features 151a, 152a, 151c, 152c ensure proper alignment of the gas cells (e.g., 120a, 120c), in the system. Suitable alignment features 151a, 152a, 151 c, 152c include, for example, a mechanical system that seals an interface between an input side 124c of one gas cell 120c and an output side 126a of an adjacent gas cell 120a. The gas cells 120a, 120c can be linked to one another by alignment features 151a, 152a, 151 c, 152c including, for example, fasteners, pins, screws, or other suitable mechanical systems and devices known to the skilled person. The mechanical system can connect multiple gas cells (e.g., 120a and 120c) by, for example, being placed between an input side 124c of one gas cell 120c and an output side 126a of an adjacent gas cell 120a. Alignment features 151a, 152a, 151c, 152c ensure adequate optical throughput of the light beam 112 through the gas cells 120a, 120c in the gas analysis system 100. The alignment features 151a, 152a, 151c, 152c ensure the integrity of the alignment of all components without requiring mechanical adjustment. Thus, it is possible to flexibly and quickly add to or remove gas cells (e.g., 120c) from the gas analysis system 100 without significant alignment and engineering redesign procedures. The alignment features 151a, 152a, 151c, 152c ensure that the light beam 112 can travel through the gas cells 120a, 120c, 120b in a series. Physically compatible gas cell 120a, 120c dimensions simplify mechanical coupling between, for example, adjacent gas cells 120a, 120c. The output side 126a of one cell 120a and the input side 124c of an adjacent cell 120c forms an interface 129, which can be sealed to prevent moisture and/or air between the adjacent gas cells 120a, 120c. Depending on the spacing between adjacent cells 120a, 120c, the interface 129 can be mechanically sealed with, for example, fasteners, pins, and/or screws or other suitable mechanical systems known to the skilled person. The interface 129 can be sealed with one or more of an o-ring, an insulating plastic, an elastomer, a polymer, or any combination of these. By sealing the interface from air and/or moisture, the signal of the light beam 112 passing through the gas cells 120a, 120c is improved.

Referring now to FIG. 2B, the gas cells 120a, 120c, 120b can be secured to a base 136. In one embodiment, one or more mechanical system 137 secures gas cell 120a to the surface of the base 136 and align gas cells. Exemplary mechanical systems 137 include, for example, a first fastener adapted to mate with a first pin and disposed on a gas inlet side 121a of the first gas cell 120a and a second fastener adapted to mate with a second pin and disposed on a gas outlet side 122a of the first gas cell 120a. Similar mechanical systems could be disposed on all or some of the gas cells in the system. In one embodiment, the base 136 can be machined to carve out a seat 138 in which the gas cell 120b sits. The gas cell 120b is aligned with the light beam 112 when it is dropped in to sit in the seat 138 located in the base 136. In one embodiment, the seat 138 is similar to valve seats present in known gas sticks (see, e.g., U.S. Pat. No. 6,186,177, which is incorporated by reference herein). One or more gas cells in a gas analysis system 100 can be secured and/or aligned by mechanical systems 137, seats 138 machined into a base 136, alignment features 151a, 152a, 151c, 152c, or any combination of these. When the gas cells 120a, 120c, 120b are disposed in place, for example, on a base 136, in a seat 138, adjacent a proximal gas cell with, for example, 151a, 152a, 151 c, 152c, the gas cells 120a, 120c, 120b self align enabling the light beam 112 to travel through the gas cells 120a, 120c, 120b in a series.

Two or more gas cells 120a, 120c, 120b can be disposed on a single base 136. Alternatively, one gas cell is disposed on a first base and another gas cell is disposed on a second base (not shown). Bases 136 can be employed to align gas cells 120a, 120c, 120b. In one embodiment, the additional gas cells (e.g., 120c) flexibly mount in the direction 170 required to connect gas cells 120a, 120c, 120b between the light source 110 and the detector 140 of the gas analysis system 100.

Modular gas cells 120a, 120c, 120b can be employed in a method of making a light path having a variable effective length. The method includes selecting a plurality of modular gas cells 120a, 120c, 120b each defining a light path 123a, 123c, 123b, respectively, and connecting the modular gas cells 120a, 120c, 120b to provide a combined light path having an effective length (e.g., the sum of the effective length of light paths 123a, 123c, 123b). The method can also include providing a light source 110 for supplying a light beam 112 to the plurality of gas cells 120a, 120c, 120b. A detector 140, for example, a detector can be provided to detect a property of the light beam associated with one or more gas cells 120a, 120c, 120b. Optionally, one or more gas cells 120a, 120c, 120b can be connected to a base 136 (FIG. 2B). Alternatively, or in addition, one of the plurality of gas cells 120a can be connected to another of the plurality of gas cells 120c, by, for example, alignment features 151a, 152a.

Referring now to FIG. 2C, optical devices 180, 181, 182, 183, such as mirror assemblies are employed to optically couple successive gas cells 120a, 120c, 120c, a light source 110, a detector 140, or any combination thereof. In addition, one or more additional gas cells (e.g., 120c), one or more optical devices 180, 181, 182, 183 (e.g., a reflecting surface, a mirror, a lens, or a combination thereof), or a combination of an additional gas cell 120c and an optical device 180, 181, 182, 183 provide a means to adjust the effective length of the light path. The means for adjusting the effective length of the light path can be an optical device 180, 181, 182, 183 for directing at least a portion of the light beam 112. For example, in one embodiment, the optical devices 181 and 182 direct at least a portion of the light beam 112 such that it makes multiple traversals through gas cell 120c. Multiple traversals of at least a portion of the light beam 112 through gas cell 120c increases the effective path length, because at least a portion of the light beam 112 travels through light path 123c multiple times. Optical devices 180, 181, 182, 183 can be employed in multiple gas cells in a single gas analysis system 100. Optical devices 180, 181, 182, 183 can direct at least a portion of the light beam 112 between gas cells (e.g., 120a, 120c) and to traverse an individual gas cell multiple times (e.g., 120c). One or more optical devices 180 can be attached to the exterior of one or more gas cell 120a.

In the modular system 100, the effective length of the light path 123 can be selected for the gas species in gas stream 220a that is delivered to the gas cell 220a. The gas cells 120a, 120c, 120b and/or optical device 180, 181, 182, 183 used in combination with the gas cells 120a, 120c, 120b can be selected to enable an effective path length (e.g., the sum of the effective path length of 123a, 123c, 123b) having a detection level suited for each gas stream 220a, 220c, 220b supplied to each gas cells 120a, 120c, 120b. Thus, gasses of different sensitivity can be measured by the modular system 100 without the expense, difficulty, and time required to change sensitivity in existing inflexible gas analysis systems. In one embodiment, a single type of gas, for example, gas “X” flow through gas streams 220a, 220c, 220b to all of the gas cells 120a, 120b, 120c in the system 100. Alternatively, each of the gas streams 220a, 220c, 220b contain gases of different sensitivities. Longer effective path lengths provide greater sensitivity relative to shorter effective path lengths. For example, low concentration gases require a relatively long path length to enable detection. In one embodiment, a low concentration gas is measured by providing the low concentration gas (e.g., gas “X” in gas streams 220a, 220c, 220b) to multiple gas cells 120a, 120c, 120c in a system, thereby increasing the effective path length. In this case, gas “X” is analyzed by an effective path length that is the sum of the effective path lengths 123a, 123c, 123b. One or more optical devices 181, 182 increase the effective path length of one or more gas cells 120c, for example, where optical devices 181, 182 provide multiple traversals through gas cell 120c the effective path length 123c increases by the number of times the portion of the light beam 112 traversed the light path 123c. In another embodiment, the low concentration gas is measured by providing the gas to one or more relatively large gas cells having a longer effective path length.

The modular system 100 enables the effective path length to be changed dynamically by, for example, supplying a single gas to the gas streams 220a, 220c, 220b that feed multiple gas cells 120a, 120c, 120b. Similarly, the effective path length can be dynamically changed by supplying distinct gases to each gas stream 220a, 220c, 220b that feeds individual gas cells 120a, 120c, 120b. Optionally, the gas streams 220a, 220c, 220b that supply gas to each gas cell 120a, 120c, 120b can feature valves that enable a single gas to be supplied to additional gas cells, to fewer gas cells, or replacement of one gas with another gas thereby dynamically changing the effective path length. Gases can be supplied to the gas analysis system 100 according to how sensitive they are to detection. For example, one or more of the gas streams 220a, 220c, 220b that supply gas to each gas cell 120a, 120c, 120b can supply non-absorbing gas, such as, for example N₂ and other of the gas streams 220a, 220c, 220b can supply an absorbing gas. Certain gases can overwhelm the detectors and thereby require a relatively short effective path length whereas other gases are less sensitive to detection and require a relatively longer effective path length for detection. For example, in one embodiment, a high concentration of a species such as, for example, SF₆ can overwhelm the detectors and require a relatively short path length to enable detection. Other gases such as HCL are less sensitive to detection and can require a longer path length to be detected. In order to enable detection, the gases can be supplied to the detector 140 according to an order such as, for example, first measuring a non-absorbing gas for example, N₂, then measuring a ga that is sensitive to detection, for example, PC's, followed by a gas that is less sensitive to detection, for example HCL. Supplying gases to the detector in stages according to detector sensitivity and/or gas concentration, strength, or sensitivity can avoid downtime caused by overwhelming the detector with a gas that is highly sensitive to detection. Alternatively, in a single analysis system 100 the gas streams 220c, 220b can supply a non-absorbing gas (e.g., N₂) to gas cells 120c, 120b and the gas stream 220a can supply a gas that is sensitive to detection (e.g., PC's) to gas cell 120a, thereby avoiding overwhelming the detector 140.

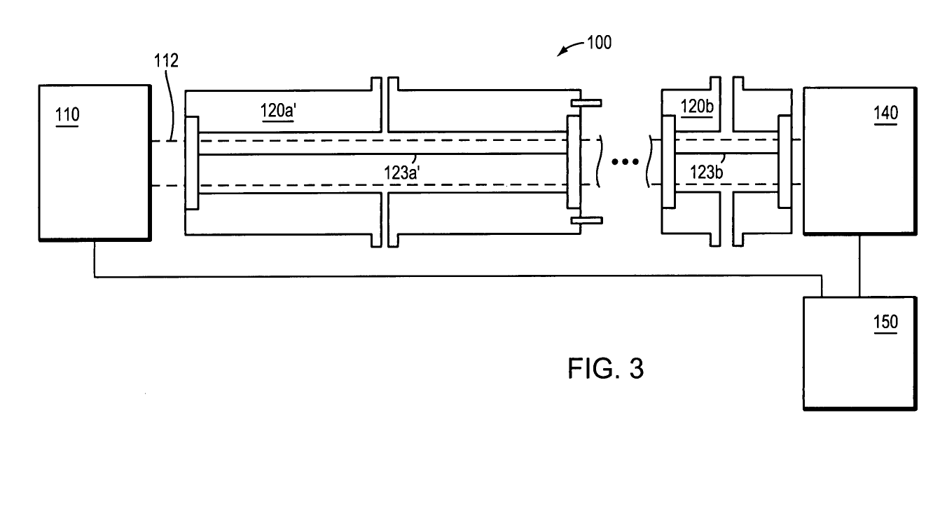

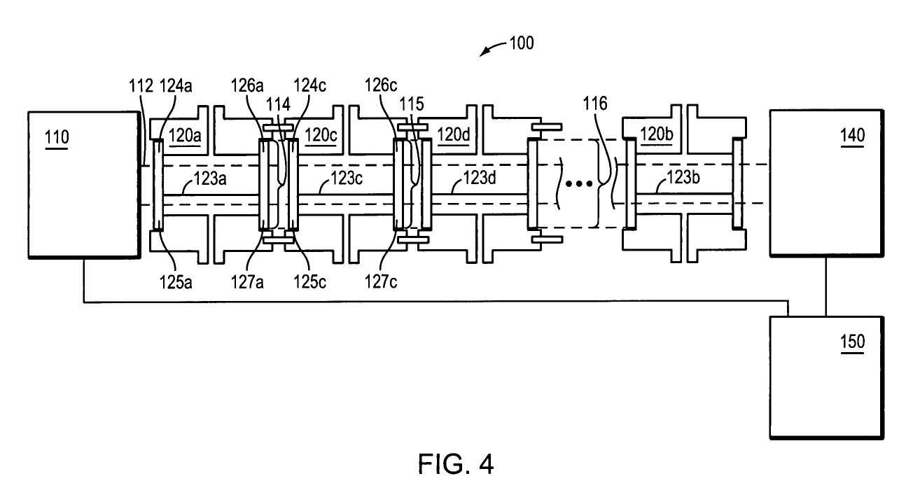

Referring now to FIGS. 3 and 4, the gas cells can be modular much like children's LEGO® block toys. In other words, a single gas cell can be sized to fit within and not exceed a footprint of space, for example, the footprint of space between the light source 110 and the detector 140. One or more of the gas cells can have a longer 120a′ effective length of light path 123a′ then the effective length of light path 123b of other of the gas cells 120b (FIG. 4). The means for adjusting the effective length of the light path can be an additional gas cell having a different effective light path length. For example, gas cell 120a′ (FIG. 3) has a relatively longer effective length of light path 123a′ compared to the effective length of light path 123a of gas cell 120a (FIG. 4). Like LEGO® blocks, the gas cells can be sized such that multiple gas cells having differing and/or similar sizes can fit within the same footprint of space. Thus, like LEGO® blocks, the system 100 can be modular and readily reconfigurable.

Specifically, FIG. 3 shows a light beam 112 that travels sequentially through a first gas cell 120a′ and a second gas cell 120b that disposed between a light source 110 and a detector 140. The detector 140 detects the light beam 112 received from the second gas cell 120b and the detector 140 detects a property of the light beam associated with the first gas cell 120a′ and the second gas cell 120b. FIG. 4 shows a light beam 112 that travels sequentially through gas cells 120a, 120c, 120d, and 120b, which are all disposed between a light source 110 and a detector 140. The detector 140 detects the light beam received from the second gas cell 120b and the detector 140 detects a property of the light beam 112 associated with gas cells 120a, 120b, 120c, and 120d. The first gas cell 120a′ (FIG. 3) is sized to substantially fit in the footpath of gas cells 120a, 120c, 120d (FIG. 4). The effective length of light path 123a′ of gas cell 120a′ can be substantially the same as the effective path length of gas cells 120a, 120c, 120d (i.e., the sum of the effective length of light paths 123a, 123c, 123d). Alternatively, the effective length of light path 123a′ of gas cell 120a′ (FIG. 3) can differ from the effective light path length of smaller gas cells 120a, 120c, 120d (FIG. 4) that fit within the same footprint. Each of the gas cells (e.g., 120a′, 120a, 120b, 120c, 120d) can readily be swapped or changed for one or more other gas cells having, for example, different sizes and/or path lengths. Because the system 100 is modular, it can readily be extended to integrate additional gas cells having substantially the same size and/or differing in size, when necessary. The modular design of additional gas cells enables no limit to the number or arrangement of gas cells in the gas analysis system 100.

By maintaining an optical interface between the modular individual gas cells (e.g., optical interface 114 between adjacent gas cells 120a and 120c, optical interface 115 between adjacent gas cells 120c and 120d, and optical interface 116 between adjacent gas cells 120d and 120b) through which the light beam 112 can travel within a system 100, it is possible to incorporate gas cells of differing internal path lengths within an assembly without requiring changes to the optics between proximate and/or serially adjacent gas cells, the light source 110, or the detector 140 (FIG. 4). In one embodiment, there is an optical interface 114, 115 between individual gas cells 120a, 120c, 120d, in series, but at least one of the modular gas cells (e.g., 120c) has a different light path effective length (e.g., 123c) then the other gas cells (e.g., 120a, 120d). In one embodiment, each of a series of gas cells (e.g., 120a, 120c, 120d, 120b) has an optical interface (e.g., 114, 115, 116) that is substantially identical. For example, the optical interface 114 is substantially identical to optical interface 115, thus each gas cell 120a, 120c enables substantially the same amount of light transmission therethrough. In one embodiment, the optical interface 114 is substantially identical to optical interface 115, thus the coincident input side 124a, 124c and output side 126a, 126c dimensions of gas cells 120a and 120c are sized to provide substantially the same amount of light transmission therethrough. In addition, the panels 125a, 125c, 127a, 127c are aligned and are substantially the same size and/or shape thereby enabling light transmission in a series through the optical interface 114 between gas cells 120a, 120c, for example. One embodiment features substantially identical optical interfaces between gas multiple gas cells, but each gas cell has a path length customized for each gas species or delivery line delivered to the gas cell. Customized path lengths enable appropriate detection levels for the species of each individual gas supplied to the gas cells.

Optionally, the detector 140 is also modular and can flexibly be changed or swapped. Also, the detector 140 can adjust as necessary as the number of gas cells within the assembly changes. Thus, in one embodiment, the detector coupling optics do not require a change when the number of gas cells in the system is changed.

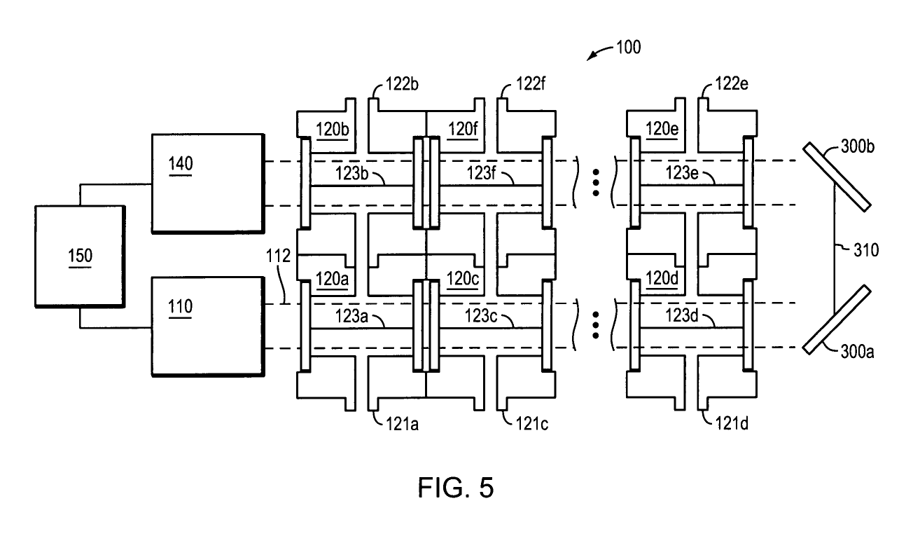

Referring now to FIG. 5, the gas analysis system 100 can also incorporate optical devices 300a, 300b that, for example, provide for a longer effective path length, greater sensitivity, and/or direct at least a portion of the light beam 112. In addition, the optical devices 300a, 300b receive and direct at least a portion of the light beam 112 through the system 100. Suitable optical devices 300a, 300b include, for example, a reflecting surface, a mirror, a lens, or any combination thereof. Such optical devices can be employed together with two or more gas cells to adjust the effective length of a light path. A first gas cell 120a receives at least a portion of the light beam 112 from the light source 110. At least a portion of the light beam 112 passes through at least a portion of the first gas cell 120a. An additional gas cell 120c is disposed adjacent to the first gas cell 120a. Gas cell 120c receives at least a portion of the light beam 112 from the first gas cell 120a and at least a portion of the light beam 112 passes through at least a portion of the gas cell 120c. Gas cell 120d is adjacent gas cell 120c. At least a portion of the light beam 112 that passes through at least a portion of the gas cell 120d hits optical device 300a. At least a portion of the light beam 112 is passed from optical device 300a to optical device 300b. At least a portion of the light beam 112 is passed from optical device 300b to gas cell 120e. At least a portion of the light beam 112 passes through at least a portion of the gas cell 120e and enters the adjacent gas cell, gas cell 120f. At least a portion of the light beam 112 passes through at least a portion of gas cell 120f. At least a portion of the light beam 112 from gas cell 120f passes through at least a portion of the second gas cell 120b. At least a portion of the light beam 112 passes through the second gas cell 120b and is detected by the detector 140. At least a portion of gas cells 120a, 120c, 120d, 120e, 120f, and 120b each define a light path 123a, 123c, 123d, 123e, 123f, and 123b having an effective length, respectively. In one embodiment, the effective length of the light path of the gas analysis system 100 is the sum of the effective lengths of light paths 123a, 123c, 123d, 123e, 123f, and 123b. In another embodiment, the effective length of the light path of the gas analysis system 100 also includes the path length 310 between optical devices (e.g., mirrors) 300a and 300b. In one embodiment, each of the gas cells 120a, 120c, 120d, 120e, 120f, and 120b has an independent gas inlet and an independent gas outlet and optionally, different gas streams flow through two or more of the gas cells 120a, 120c, 120d, 120e, 120f, and 120b via each independent gas inlet and gas outlet.

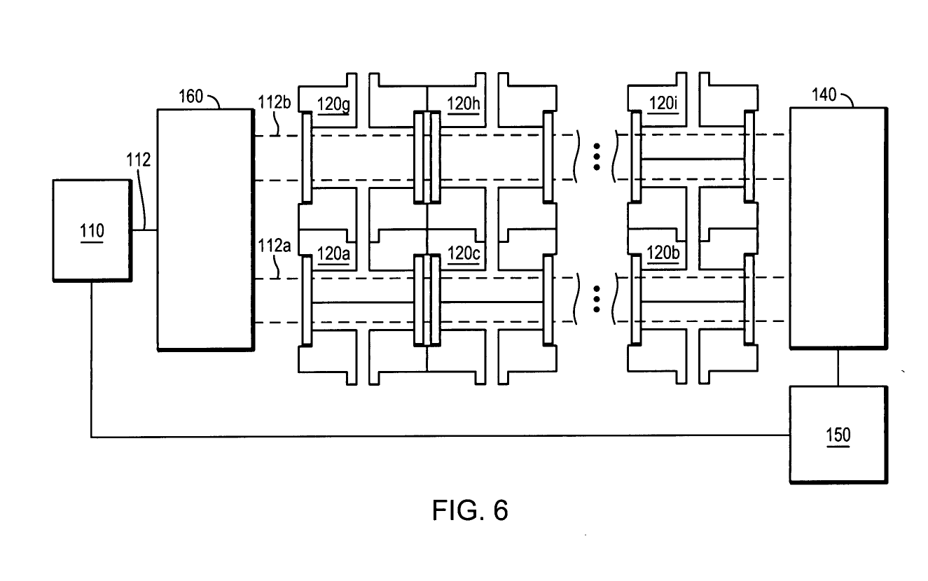

Optionally, referring now to FIG. 6, the light source 110 transmits a single light beam 112. The single light beam 112 passes through a beam splitter 160 where the light beam 112 is split into two separate beams 112a, 112b. The first split beam 112a sequentially passes through gas cells 120a, 120c, 120b and at least a portion of the light beam 112a is detected by the detector 140. The second split beam 112b sequentially passes through gas cells 120g, 120h, and 120i and at least a portion of light beam 112b is detected by the detector 140. Optionally, one or more optical device directs at least a portion of light beams 112a and 112b from the gas cells 120a, 120c, 120b and 120g, 120h, 120i into the detector 140. Because the split light beam 112a, 112b is transmitted through at least a portion of two or more gas cells 120a, 120c, 120b, 120g, 120h, and 120i, it is possible to simultaneously measure multiple gas streams (including multiple streams of a same gas) flowing through gas cells 120a, 120c, 120b, 120g, 120h, and 120i, using a single light source 110 and detector 140. At least a portion of gas cells 120a, 120c, 120b, 120g, 120h, and 120i each define an effective light path length. In one embodiment, the effective length of the light path is the sum of the effective lengths of the light paths in each gas cell 120a, 120c, 120b, 120g, 120h, and 120i. Each gas cell 120a, 120b, 120c, 120g, 120h, and 120i defines a volume. In one embodiment, the detector 140 receives at least a portion of the light beam 112a from the volume of gas cell 120b and the detector 140 detects a property of the light beam associated with the volume of gas cells 120a, 120c, 120b. Simultaneously, or serially, the detector 140 also receives at least a portion of the light beam 112b from the volume of gas cell 120i and the detector 140 detects a property of the light beam associated with the volume of gas cells 120g, 120h, 120i.

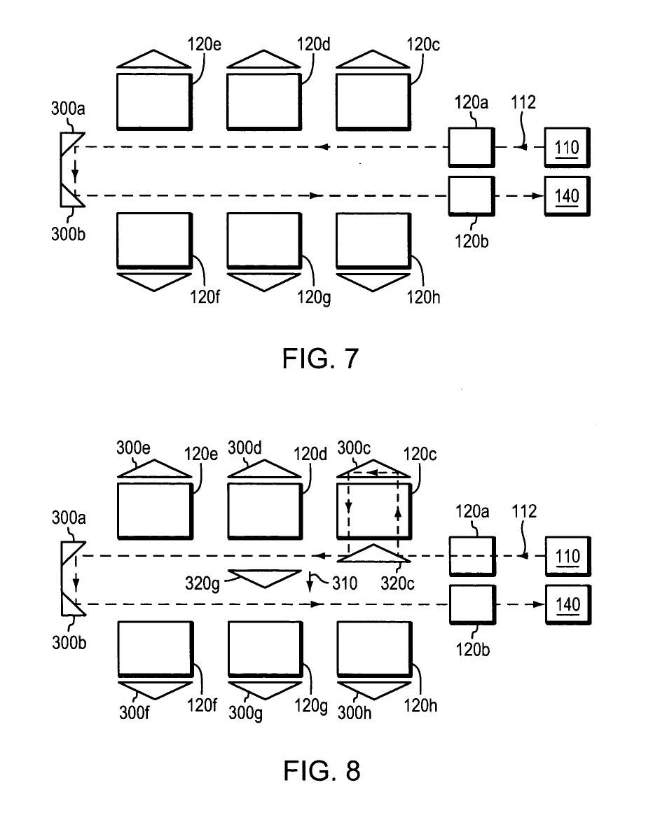

Referring to FIGS. 7 and 8, in one embodiment, the system features two or more gas cells 120a, 120b, one or more optical device 320c, 320g, and a means for moving the optical device 320c, 320g, relative to a light beam 112 that passes through the gas cells 120a, 120b. In this way, the optical device 320c, 320g, can be moved relative to the light beam 112 to bring certain gas cells (e.g., 120c, 120g) into the path of the light beam 112. In one embodiment, a first gas cell 120a and a second gas cell 120b are disposed between a light source 110 and a detector 140. At least a portion of the light beam 112 passes through the first gas cell 120a and at least a portion of the light beam 112 passes through the second gas cell 120b and is detected by detector 140. In one embodiment, the portion of the light beam that passes through the first gas cell 120a hits optical device 300a and is passed from optical device 300a to optical device 300b. At least a portion of the light beam 112 is passed from optical device 300b to gas cell 120b (FIG. 7).

An optical device 320c is positioned relative to the portion of the light beam that passes through the first gas cell 120a. The optical device 320c directs the portion of the light beam 112 that passes through the first gas cell 120a through gas cell 120c (FIG. 8). The portion of the light beam that travels through gas cell 120c hits optical device 300c and is directed in reverse back through gas cell 120c. The portion of the light beam hits the optical device 320c and is directed through gas cell 120c toward optical device 300a. At least a portion of the light beam is passed from optical device 300a to optical device 300b. At least a portion of the light beam 112 is passed from optical device 300b to gas cell 120b. At least a portion of the light beam 112 passes through the second gas cell 120b and the detector 140 detects the light beam received form the second gas cell 120b. The optical device 320c directs at least a portion of the light beam 112 received from the light source 110, the first gas cell 120a, or the second gas cell 120b. The detector 140 detects a property of the light beam associated with gas cells 120a, 120c, and 120b. In one embodiment, the property is the light beam intensity at one or more wavelength. Optionally, the detector detects the concentration of each gas flowing through gas cells 120a, 120c, and 120b. Alternatively, or in addition, the detector detects the concentration of a contaminant in gas cells 120a, 120c, and 120b. In one embodiment, the detector 140 and/or a processor compensates its measurement to account for the light passing through gas cell 120c two times.

The optical device 320g can be moved relative to the light beam 112 that passes through the gas cells. Specifically, the optical device 320g can be moved from, for example, a position at a side of the light beam 112 into the light beam (e.g., in the horizontal direction 310). Alternatively, the optical device 320g can be moved from, for example, above or below the light beam 112 into the light beam 112 (e.g., in the vertical direction). Suitable means for moving the optical device into the path of the light beam include electrical means, mechanical means (e.g., pushing, sliding the optical device into place), or a combination of electrical and mechanical means, for example, an automated system that moves the optical device (e.g., 320c, 320g), into the path of the light beam 112 when certain gas cells are desired to be monitored. Any other suitable means for moving the optical device into the path of the light beam 112 that are known to the skilled person can also be employed. When an optical device is moved into the path of the light beam 112, any of a number of additional gas cells and/or optical devices can become part of the effective path length of the system.

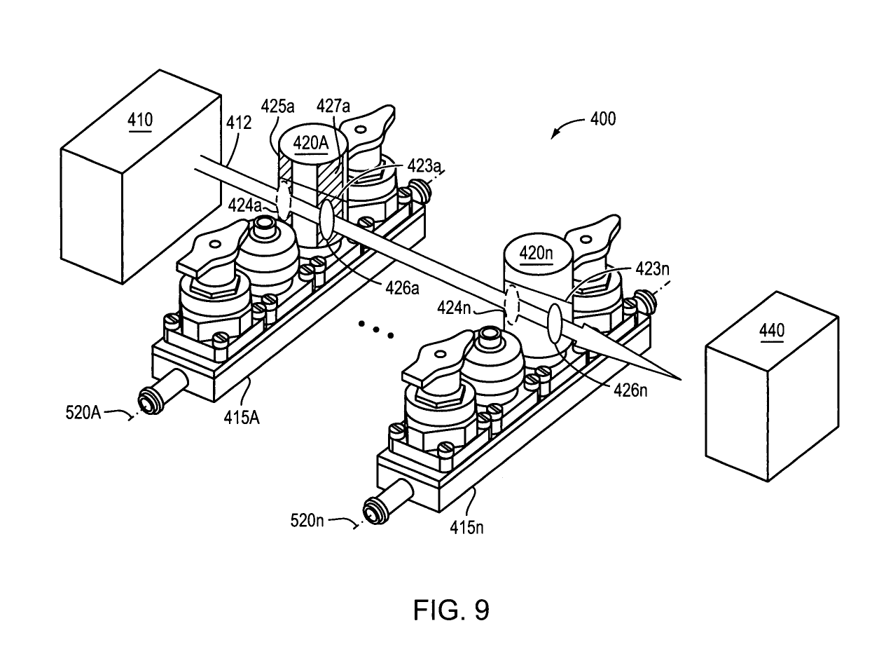

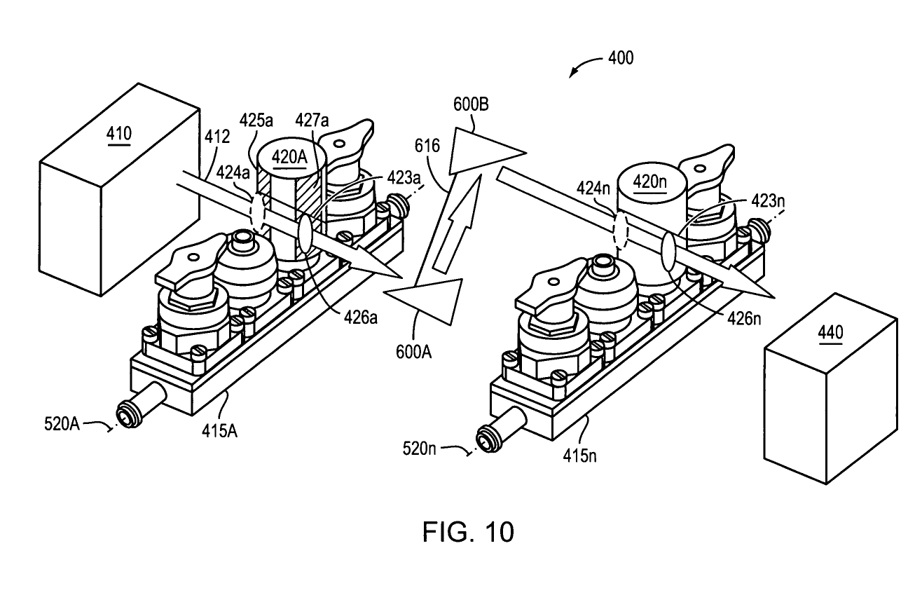

The gas analysis system 100 is compatible with presently available gas delivery systems including gas sticks. A gas stick is an assembly of components that usually includes pressure, flow control, filtration, and valves. A process tool contains any of a number of gas sticks, for example, one process tool includes between four and 40 gas sticks. Most semiconductor fabrication systems contain several thousand gas sticks. Referring now to FIGS. 9 and 10 two or more gas sticks 415a, 415n, each including at least one gas cell 420a, 420n, are arranged between a light source 410 and a detector 440. The system can feature any of a number of gas sticks. In one embodiment, one gas cell 420a is disposed on one gas stick 415a and another gas cell 420n is disposed on another gas stick 415n. Optionally, two or more gas cells can be on a single gas stick (not shown). In one embodiment, upon placement within the gas stick 415a the gas cell 420a aligns itself thereby enabling a light beam 412 to pass through the gas cell 420a. Gases 520a, 520n, flow through gas sticks 415a, 415n, respectively. A single gas or multiple gases can flow through each gas stick 415a, 415n and simultaneously be detected and analyzed by a single detector 440. The gas analysis system can be a simple single pass system (FIG. 9). Alternatively, the gas analysis system 400 can feature one or more optical device 600a, 600b, such as, for example, mirrors (FIG. 10). In one embodiment, the gas sticks are used in 300 mm semiconductor process lines. The first gas cell 420a disposed on gas stick 415a receives at least a portion of a light beam 412 from a light source 410. At least a portion of the light beam 412 passes through at least a portion of the first gas cell 420a. Gas cell 420a has an input side 424a and an output side 426a. All or a portion of the gas cell 420 can be made from materials capable of passing light, such as, for example, glass, polymers, or other suitable materials. In one embodiment, gas cell 420a has a first panel 425a and a second panel 427a, and each panel 425a, 427a is capable of passing light. At least a portion of the second panel 427a is coincident with the first panel 425a and at least a portion of the light 412 beam travels through the first panel 425a and the coincident portion of the second panel 427a. A second gas cell 420n is proximate to the first gas cell 420a and is made entirely from materials capable of passing light. The second gas cell 420n disposed on gas stick 415n and receives at least a portion of the light beam 412 from the first gas cell 420a. At least a portion of the light beam 412 enters the input side 424n passes through at least a portion of the second gas cell 420n and exits the output side 426n. Specifically, at least a portion of the light beam 412 that exits the second panel 427a, enters the second gas cell 420n and travels through the second gas cell 420n. The coincident portion of the input side 424a, 424n and the output side 426a, 426n of each gas cell 420a, 420n provides an optical interface through which at least a portion of the light beam 412 can travel through each gas cell 420a, 420n. At least a portion of the first gas cell 420a and at least a portion of the second gas cell 420n define a light path 423a, 423n and the system 400 has an effective light path length (e.g., the sum of the effective lengths of light paths 423a. 423n). A means for adjusting the effective length of the light path includes an additional gas cell disposed, for example, on an additional gas stick (not shown). In one embodiment, each of the gas cells 420a, 420n, define a volume through which the light beam 412 passes. In one embodiment, the detector 440 is an InDuct analyzer that detects the property of the light beam 412. In one embodiment, the property associated with the process gases 520a, 520n delivered to gas cells 420a, 420n through the gas sticks 415a, 415n, respectively. The gas cells 420a, 420n, can be configured to drop into the gas stick 425a, 415n.

In one embodiment, gas sticks 415a, 415n are employed to supply gasses 520a, 520n to a semiconductor fabrication process. In one embodiment, the gas analysis system 400 is used to measure concentrations of process gases 520a, 520n delivered via gas sticks 415a, 415n to, for example, semiconductor deposition or etch tools. The gas analysis system 400 enables multiple processes gases 520a, 520n entering the semiconductor deposition chamber to be analyzed prior to being mixed within the semiconductor deposition chamber. This can avoid cross contamination caused by mixing and/or avoid downtime. In addition, the present gas analysis system 400, in contrast to prior systems, does not require combining multiple gas streams in order to measure them. The gas analysis system 400 also enables determination of the total contaminant count reaching the process, so that action can be taken as necessary to determine and correct the source of contamination. Accordingly, troubleshooting a contamination and/or concentration issue in a system featuring multiple gas delivery streams 520a, 520n is simplified. In addition, the gas analysis system 400 enables adjustment of the effective length of the light path of the gas analysis system 400 to provide an effective length of light path suitable to measure certain of the process gases 520a, 520n. The gas analysis system 400 is flexible, enabling changes in type of gases, concentration of gases, and volumes of gases without requiring system redesign. The flexibility enables space requirements of the gas analysis system 400 to be suited to the process application, avoiding unnecessary waste of process area space.

The footprint of the gas analysis system 400 is determined by the dimensions of the gas stick, e.g., the width, of the mass flow controller. In one embodiment, the InDuct system is adapted to include a gas cell drop in feature. A light source provides a light beam, which passes serially through two or more gas cells dropped into the gas stick and the InDuct system detects at least a portion of the light beam received from the two or more gas cells. In one embodiment, gas is delivered to the gas cells by holes in the bottom of each gas cell. The gas analysis system can be adapted to integrate with any of a number of gas delivery systems and products.

Gases can be flowed into gas cells in any of a number of ways that enable gas analysis using a single light beam and a single detector. In one embodiment, gas cells are coupled to the system to be analyzed according to methods that are compatible with other system components including gas delivery components such as flow controllers, for example. Two common approaches for gas delivery to components include surface mount and in-line delivery, which can be used to deliver gas to the modular gas cells. Adapting existing gas systems to use modular gas cells simplifies engineering, manufacturing, and integration of modular gas cells and/or the gas analysis system into currently used manufacturing and laboratory applications.

### EQUIVALENTS

While the invention has been particularly shown and described with reference to specific preferred embodiments, it should be understood by those skilled in the art that various changes in form and detail can be made therein without departing from the spirit and scope of the invention as defined by the appended claims.

What is claimed is:

1. A modular system for gas analysis, the system comprising:
a light source providing a light beam;
a first modular gas cell comprising an input side having a first panel and an output side having a second panel, at least a portion of the second panel is coincident with the first panel, the first modular gas cell receiving at least a portion of the light beam, at least a portion of the light beam passing through the first panel and the coincident portion of the second panel;
a second modular gas cell disposed proximal to the first modular gas cell, the second modular gas cell comprising an input side having a third panel and an output side having a fourth panel, at least a portion of the fourth panel is coincident with the third panel, the second modular gas cell receiving at least a portion of the light beam from the first modular gas cell, at least a portion of the light beam passing through the third panel and the coincident portion of the fourth panel;
a light path having an effective length, the light path defined by at least a portion of the first modular gas cell and at least a portion of the second modular gas cell;
a means for adjusting the effective length of the light path to vary a property of the light beam; and
a detector detecting the light beam received from the second modular gas cell.

2. The system of claim 1 wherein the light beam is an infrared light beam, an ultraviolet light beam, a visual light beam, or any combination thereof.

3. The system of claim 1 wherein the property of the light beam is a light beam intensity at one or more wavelength.

4. The system of claim 1 wherein the means for adjusting the effective length of the light path comprises at least a portion of one or more additional gas cells disposed proximal to the first gas cell.

5. The system of claim 1 wherein the means for adjusting the effective length of the light path comprises one or more optical devices disposed proximal to the first gas cell or one or more optical devices disposed proximal to the second gas cell, the one or more optical devices for directing the light beam.

6. The system of claim 5 wherein the one or more optical devices is a mirror, lens, or any combination thereof.

7. The system of claim 1 wherein the means for adjusting the effective length of the light path comprises an additional gas cell disposed proximal to the first gas cell and an optical device for directing the light beam.

8. The system of claim 1 wherein an o-ring, a polymer, an elastomer or a combination thereof is disposed between the input side of the second gas cell and the output side of the first gas cell.

9. The system of claim 1 wherein a mechanical system seals an interface between the input side of the second gas cell and the output side of the first gas cell.

10. The system of claim 1 wherein a mechanical system couples the input side of the second gas cell and the output side of the first gas cell.

11. The system of claim 1 wherein the light beam property is infrared light beam absorbance.

12. The system of claim 1 wherein a first gas flows through the first gas cell and a second gas flows through the second gas cell.

13. The system of claim 12 wherein the means for adjusting the effective length of the light path comprises changing the first gas flow relative to the second gas flow.

14. The system of claim 1 wherein the means for adjusting the effective length of the light path comprises changing the cells through which the gas flows.

15. The system of claim 12 wherein the first gas is a different gas than the second gas.

16. The system of claim 12 wherein the first gas is not absorbed by infrared light and the second gas is absorbed by infrared light.

17. The system of claim 12 further comprising a gas analyzer for analyzing the property of the light beam associated with one or more gas cells to determine the concentration of the first gas and the second gas.

18. The system of claim 12 further comprising a gas analyzer for analyzing the property of the light beam associated with one or more gas cells to determine the total contaminant level of the first gas and the second gas.

19. The system of claim 12 further comprising a processor for converting the detected light beam into data.

20. A modular system for gas analysis, the system comprising:
a first gas cell receiving at least a portion of a light beam from a light source, at least a portion of the light beam passing through at least a portion of the first gas cell;
a second gas cell disposed proximal to the first gas cell, the second gas cell receiving at least a portion of the light beam from the first gas cell, at least a portion of the light beam passing through at least a portion of the second gas cell,
wherein at least a portion of the first gas cell and at least a portion of the second gas cell define a light path having an effective length; and
a means for adjusting the effective length of the light path to vary a property of the light beam.

21. The system of claim 20 further comprising a light source supplying an infrared light beam, an ultraviolet light beam, a visual light beam, or any combination thereof.

22. The system of claim 20 further comprising a detector for detecting the property of the light beam associated with one or more gas cells.

23. The system of claim 22 wherein the detector detects the light beam received from the second-gas cell.

24. The system of claim 20 wherein the property of the light beam is a light beam intensity at one or more wavelength.

25. The system of claim 20 wherein the means for adjusting the effective length of the light path comprises at least a portion of one or more additional gas cells disposed proximal to the first gas cell.

26. The system of claim 25 wherein one or more gas cells are at least substantially the same size and shape.

27. The system of claim 25 wherein one or more gas cells are modular.

28. The system of claim 20 wherein the means for adjusting the effective length of the light path comprises one or more optical devices disposed proximal to the first gas cell or one or more optical devices disposed proximal to the second gas cell, the one or more optical devices for directing the light beam.

29. The system of claim 28 wherein the one or more optical devices is a mirror, lens, or any combination thereof.

30. The system of claim 20 wherein the means for adjusting the effective length of the light path comprises an additional gas cell disposed proximal to the first gas cell and an optical device for directing the light beam.

31. The system of claim 20 wherein the first gas cell is disposed on a first base and the second gas cell is disposed on a second base.

32. The system of claim 20 wherein the first gas cell and the second gas cell are disposed on a base.

33. The system of claim 20 wherein an o-ring, a polymer, an elastomer or a combination thereof is disposed between an input side of the second gas cell and an output side of the first gas cell.

34. The system of claim 20 wherein a mechanical system seals an interface between an input side of the second gas cell and an output side of the first gas cell.

35. The system of claim 20 wherein the first gas cell comprises an input side having a first panel and an output side having a second panel, at least a portion of the second panel is coincident with the first panel, and the light beam travels through the first panel and the coincident portion of the second panel.

36. The system of claim 20 wherein each gas cell defines a light path length and the means for adjusting the effective length of the light path comprises a means for adjusting the light path length of one or more gas cells.

37. The system of claim 20 wherein the means for adjusting the effective length of the light path comprises at least one valve for controlling the flow of a gas to at least one gas cell.

38. The system of claim 20 further comprising a means to identify a substance in one or more gas cells.

39. The system of claim 38 wherein the means to identify a substance in one or more gas cells comprises altering a first gas flowing through the first gas cell relative to a second gas flowing through the second gas cell.

40. The system of claim 38 wherein a first gas flows through the first gas cell, a second gas flows through the second gas cell, and:
the first gas flows at a first pressure and the second gas flows at a second pressure;
the first gas is a first temperature and the second gas is a second temperature;
the first gas flows at a first pressure and is a first temperature and the second gas flows at a second pressure and is a second temperature;
the first gas is absorbed by infrared light and the second gas is not absorbed by infrared light;
the first gas is the same as the second gas; or
the first gas and the second gas are absorbed by infrared light.

41. The system of claim 38 further comprising a means to quantify one or more substances in the system.

42. The system of claim 38 further comprising a means to quantify one or more substances exiting the system.

43. A system for gas analysis, the system comprising:
a first gas cell defining a first volume, receiving at least a portion of a light beam from a light source, at least a portion of the light beam passing through at least a portion of the first volume;
a second gas cell disposed proximal to the first gas cell, the second gas cell defining a second volume, receiving at least a portion of the light beam from the first volume, at least a portion of the light beam passing through at least a portion of the second volume; and
a detector receiving at least a portion of the light beam from the second volume, the detector detecting a property of the light beam.

44. The system of claim 43 wherein the detector detects a property of the light beam associated with one or more gas cells.

45. The system of claim 43 wherein the light beam property is infrared light beam absorbance.

46. The system of claim 43 further comprising a light source supplying an infrared light beam, an ultraviolet light beam, a visual light beam, or any combination thereof.

47. The system of claim 43 further comprising one or more additional gas cell defining a volume and disposed proximal to the first gas cell.

48. The system of claim 43 further comprising one or more optical devices disposed proximal to the first gas cell or one or more optical devices disposed proximal to the second gas cell, the one or more optical devices for directing the light beam.

49. The system of claim 43 further comprising an additional gas cell defining a volume and disposed proximal to the first gas cell and an optical device for directing the light beam.

50. The system of claim 43 wherein the first gas cell comprises an input side comprising a first panel and an output side comprising a second panel, at least a portion of the second panel is coincident with the first panel, and the light beam travels through the first panel and the coincident portion of the second panel.

51. The system of claim 43 wherein a first gas flows through the first volume and a second gas flows through the second volume.

52. The system of claim 51 wherein the first gas is a different gas than the second gas.

53. The system of claim 51 wherein the first gas is not absorbed by infrared light and the second gas is absorbed by infrared light.

54. The system of claim 51 further comprising a gas analyzer for analyzing the property of the light beam associated with one or more gas cells to determine the concentration of the first gas and the second gas.

55. The system of claim 51 further comprising a gas analyzer for analyzing the property of the light beam associated with one or more gas cells to determine the total contaminant level of the first gas and the second gas.

56. A method of making a light path having a variable effective length, the method comprising:
selecting a plurality of modular gas cells each defining a light path; and
connecting the modular gas cells to provide a combined light path having an effective length.

57. The method of claim 56 further comprising providing a light source for supplying an infrared light beam, an ultraviolet light beam, a visual light beam, or any combination thereof to the plurality of gas cells.

58. The method of claim 56 further comprising the step of:
providing a detector for detecting a property of the light beam associated with one or more gas cells.

59. The method of claim 56 the method further comprising:
providing a base; and
connecting one or more of the plurality of gas cells to the base.

60. The method of claim 56 the method further comprising:
connecting one of the plurality of gas cells to another of the plurality of gas cells.

61. The method of claim 56 the method further comprising:
flowing a first gas through one of the plurality of gas cells; and
flowing a second gas through another of the plurality of gas cells.

62. The method of claim 61 wherein the first gas is not absorbed by infrared light and the second gas is absorbed by infrared light.

63. A method of making a detector, the method comprising:
providing a plurality of gas cells defining a light path;
positioning relative to a gas cell a light source for supplying a light beam to the light path; and
connecting relative to the light path a detector for detecting the light beam received from the light path.

64. The method of claim 63 further comprising the step of:
disposing proximal to the first gas cell or the second gas cell one or more optical devices for directing the light beam.

65. A system for gas analysis, the system comprising:
a first gas cell receiving at least a portion of a light beam from a light source, at least a portion of the light beam passing through at least a portion of the first gas cell;
a second gas cell receiving at least a portion of the light beam from the first gas cell, at least a portion of the light beam passing through at least a portion of the second gas cell;
an optical device directing at least a portion of the light beam received from the light source, the first gas cell, or the second gas cell; and
a means for moving the optical device relative to the light beam.
